(19) United States
(12) Patent Application Publication
(10) Pub. No.: US 2018/0257862 A1
(43) Pub. Date: Sep. 13, 2018

(54) CARRIAGE FOR AN AUTOMATIC DISPENSER OF PREPARED FOOD PRODUCTS, NOTABLY PIZZA

(71) Applicant: ADIAL, Lisieux (FR)

(72) Inventor: Antony Goupil, Saint Desir (FR)

(21) Appl. No.: 15/891,732

(22) Filed: Feb. 8, 2018

(30) Foreign Application Priority Data
Mar. 7, 2017 (FR) 1751835

(51) Int. Cl. B65G 1/137; B65G 1/133; B65G 1/04; G07F 9/10; G07F 17/00

(52) U.S. Cl. CPC B65G 1/137; B65G 1/133; B65G 2201/025; G07F 9/105; G07F 17/0078; B65G 1/0478

(57) ABSTRACT

Disclosed is a carriage for an automatic dispenser of prepared food products including a frame, and a gripping device designed for grasping a cardboard box, the gripping device including a pair of jaws each hinged on a support between a closed position in which the jaws grip the cardboard box and an open position in which the jaws release the cardboard box. The gripping device moves in translation between a forward position in which the jaws are in the closed position and grip the cardboard box and a retracted position, the gripping device also including first elastic return members designed to return each of the jaws to the closed position and a blocking piece designed for blocking the jaws in the open position, when the gripping device moves from the retracted position to the forward position, and to release the jaws when the gripping device is in the forward position.

### TECHNICAL FIELD

The invention relates to a carriage for an automatic dispenser of prepared food products, notably pizza, and an automatic dispenser of prepared food products comprising said carriage.

### PRIOR ART

Conventionally, an automatic pizza dispenser comprises a user interface by which a user selects the pizza that he wants to buy, a storage compartment in which one or more pizza boxes comprising a raw or frozen pizza are stored and a cooking and delivery compartment communicating with the storage compartment and in which the pizza previously selected by a user is cooked in its pizza box and then delivered to the user via a delivery opening.

The storage compartment comprises for example shelves on which the pizza box or boxes are stored and a carriage designed for grasping, by plucking or gripping from the shelves, the pizza box corresponding to the pizza selected by the user and for conveying said pizza box to the cooking and delivery compartment.

For this purpose, the carriage may comprise a frame and a gripping device mounted to be movable in translation on the frame between a retracted position and a forward position in which the gripping device grasps the selected pizza box.

In order to grasp the selected pizza box, the gripping device comprises a pair of articulated jaws on a support between a closed position in which the jaws grasp the selected pizza box, and an open position. By default, the jaws are kept in the closed position by elastic return members mounted between each of the jaws and the support of the gripping device and they only open under the action of a force opposing that exerted by the elastic return members.

Thus, grasping of the pizza box selected by the user and conveyance thereof to the cooking and delivery compartment take place as follows.

Firstly, the gripping device moves from the retracted position to the forward position. The jaws are then in the closed position and remain so until they come into contact with a side wall of the selected pizza box facing the carriage.

The jaws then open under the effect of the movement of the gripping device to the forward position and the reactive force applied by the pizza box on the jaws. An inclined profile forming a cam of each of the jaws slides along the side wall of the pizza box towards the corner that is adjacent to them.

When the cam of each jaw passes the corner of the pizza box that is adjacent to them, the force that was exerted by the pizza box on each of the jaws and that tended to open them is released so that the jaws close on the opposite side walls of the pizza box and thus grasp the pizza box. The gripping device is then in the forward position and the jaws are once again in the closed position and are tightened elastically.

Then the gripping device moves from the forward position to the retracted position to take the pizza box out of the shelves, it being held by the jaws.

At the end of travel of the gripping device, the pizza box is released from the jaws under the effect of a stop that said pizza box comes up against and of the movement of the gripping device to the retracted position, thus forcing the jaws to open.

The pizza box can then be conveyed to the cooking and delivery compartment for cooking the pizza that it contains, and finally the pizza box containing the cooked pizza is delivered to the user.

When the pizza box is not sufficiently rigid or when it has been softened by the humidity prevailing in the storage compartment, or when the pizza box has not been positioned centrally enough relative to the jaws of the gripping device, it may happen that the jaws do not succeed in grasping it.

The automatic pizza dispenser is then unable to deliver the pizza selected by the user.

There is therefore a need to increase the reliability with which the jaws of the gripping device of the carriage grasp the pizza box.

### BRIEF DESCRIPTION OF THE INVENTION

The aim of the present invention is to overcome these drawbacks, notably by proposing a carriage for an automatic dispenser of prepared food products, improving the reliability with which the jaws of the gripping device of said carriage grasp the cardboard box comprising the prepared food product selected by a user.

More precisely, the invention relates to a carriage for an automatic dispenser of prepared food products, notably pizza, comprising:
a frame,
at least one gripping device designed for grasping a cardboard box comprising a prepared food product,
said gripping device comprising:
   a support,
   a pair of jaws each hinged on the support about a swivel axis in opposite first and second directions of swivelling,
      each of the jaws being designed for swivelling about its swivel axis between a closed position in which said jaws grip the cardboard box and an open position in which the jaws release the cardboard box,
   first elastic return members designed for returning each of the jaws to the closed position by swivelling in the first direction of swivelling about its swivel axis,
the support being mounted movably in translation relative to the frame along a first axis of translation, roughly orthogonal with respect to the swivel axes of the jaws, the gripping device being designed for moving in translation relative to the frame along the first axis of translation between a forward position, in which the jaws are in the closed position and grip the cardboard box, and a retracted position.

The gripping device further comprises a blocking piece designed for blocking the jaws in the open position, when the gripping device moves from the retracted position to the forward position, and for releasing the jaws when the gripping device reaches the forward position.

According to various embodiments of the invention, which can be taken together or separately:
the blocking piece is mounted tilting on the support in first and second opposite directions of tilting about a tilting axis, roughly orthogonal to the axes of articulation of the jaws, between a blocking position in which each of the jaws is blocked by swivelling in the first direction of swivelling, when the jaws are in the open position, and a release position in which each of the jaws is free to swivel about its swivel axis relative to the blocking piece;
the blocking piece is designed to tilt in the second direction of tilting about the tilting axis from the blocking position to the release position, when the gripping device moves from the retracted position to the forward position, to release the jaws by swivelling;
the frame comprises a first blocking surface designed to cause the blocking piece to tilt in the second direction of tilting about the tilting axis from the blocking position to the release position, when the gripping device moves from the retracted position to the forward position;
the blocking piece comprises a first blocking surface against which the jaws bear, when the blocking piece is in the blocking position and the jaws are in the open position;
the blocking piece comprises second elastic return members designed for returning the blocking piece to the blocking position by tilting in the first direction of tilting about the tilting axis;
the frame comprises a second blocking surface designed to cause each of the jaws to swivel in the second direction of swivelling about its swivel axis from the closed position to the open position, when the gripping device moves relative to the frame from the forward position to the retracted position;
the jaws are moreover designed to:
   cause the blocking piece to tilt in the second direction of tilting about the tilting axis from the blocking position to the release position, when the gripping device moves from the forward position to the retracted position and each of the jaws swivels in the second direction of swivelling about the swivel axis from the closed position to the open position, and
   release the blocking piece when the jaws reach the open position and the blocking piece reaches the release position;
the blocking piece comprises a cam surface that interacts with the jaws when said jaws cause the blocking piece to tilt in the second direction of tilting about the tilting axis from the blocking position to the release position.

The invention also relates to a dispenser of prepared food products, notably pizza, comprising a carriage as described above.

### BRIEF DESCRIPTION OF THE DRAWINGS

Other features and advantages of the invention will become clear on reading the following detailed description, for understanding which reference may be made to the appended drawings in which:

FIG. 1 is a partial bottom view of a carriage for an automatic dispenser of prepared food products according to one embodiment of the invention, in which a gripping device of the carriage moves to a forward position;

FIG. 2 is a detail view from FIG. 1;

FIG. 3 is a partial perspective view of the carriage illustrated in FIGS. 1 and 2, in which the gripping device of the carriage moves to a forward position;

FIG. 4 is a partial bottom view of the carriage illustrated in FIGS. 1 to 3, in which the gripping device of the carriage moves to a retracted position;

FIG. 5 is a perspective view of a blocking piece of the carriage illustrated in FIGS. 1 to 4;

FIG. 6 is a front view of the carriage illustrated in FIGS. 1 to 4, in which the gripping device is in the retracted position;

FIG. 7 is a schematic profile view of an automatic dispenser of prepared food products comprising the carriage illustrated in FIGS. 1 to 6.

### DETAILED DESCRIPTION

Firstly, an orthonormal coordinate system is defined comprising a longitudinal direction X, a transverse direction Y and a vertical direction Z, the longitudinal and transverse directions X, Y being horizontal.

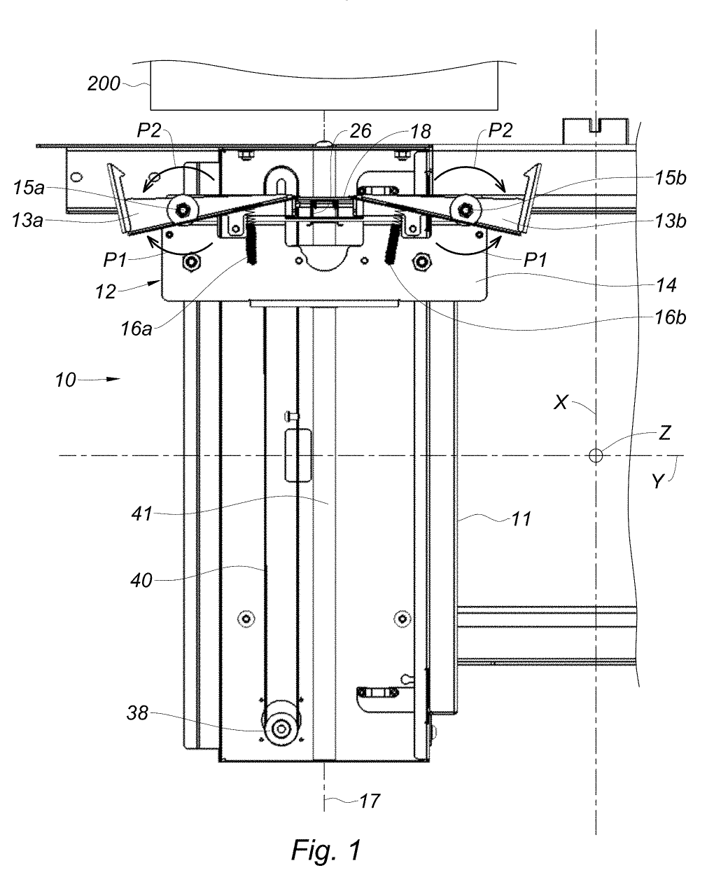

FIGS. 1 to 6 show a carriage 10 for an automatic dispenser 100 of prepared food products according to one embodiment of the invention.

The prepared food products may be raw or frozen.

The prepared food products comprise, for example, pizzas and/or quiches.

The carriage 10 comprises a frame 11 and at least one gripping device 12 designed for grasping a cardboard box 200 comprising a prepared food product.

The carriage 10 comprises, for example, two gripping devices 12 arranged on either side of a plane formed by the longitudinal direction X and the vertical direction Z. Only one of the two gripping devices 12 is shown in FIGS. 1 to 3.

The cardboard box 200 is for example of parallelepipedal shape. It comprises a flat base, which may be rectangular, square or hexagonal, and rectangular flat side walls extending roughly perpendicularly from the base. Together, the base and the side walls define a space that receives the prepared food product. The cardboard box 200 further comprises a lid that is hinged on one of the side walls for closing the space defined by the base and the side walls. The lid comprises for example a flat part of the same shape as the base and that is arranged parallel to said base, when the lid covers the space, and flat fins extending roughly perpendicularly from the flat part of the lid towards the base, when the lid covers the space. The fins are for example intended to be arranged inside the space defined by the base and the side walls, when it is closed by the lid.

The cardboard box 200 is arranged relative to the carriage 10 so that its base is arranged roughly perpendicularly to the vertical direction Z and so that one of its side walls is arranged roughly perpendicularly to the longitudinal direction X and opposite the carriage 10.

The gripping device 12 comprises a pair of jaws 13a, 13b and a support 14 on which each of the jaws 13a, 13b is hinged about a swivel axis 15a, 15b in opposite first and second directions of swivelling P1, P2.

The swivel axes 15a, 15b are roughly parallel to one another. The swivel axes 15a, 15b are, for example, roughly parallel to the vertical direction Z.

Each of the jaws 13a, 13b is designed to swivel about its swivel axis 15a, 15b between an open position and a closed position.

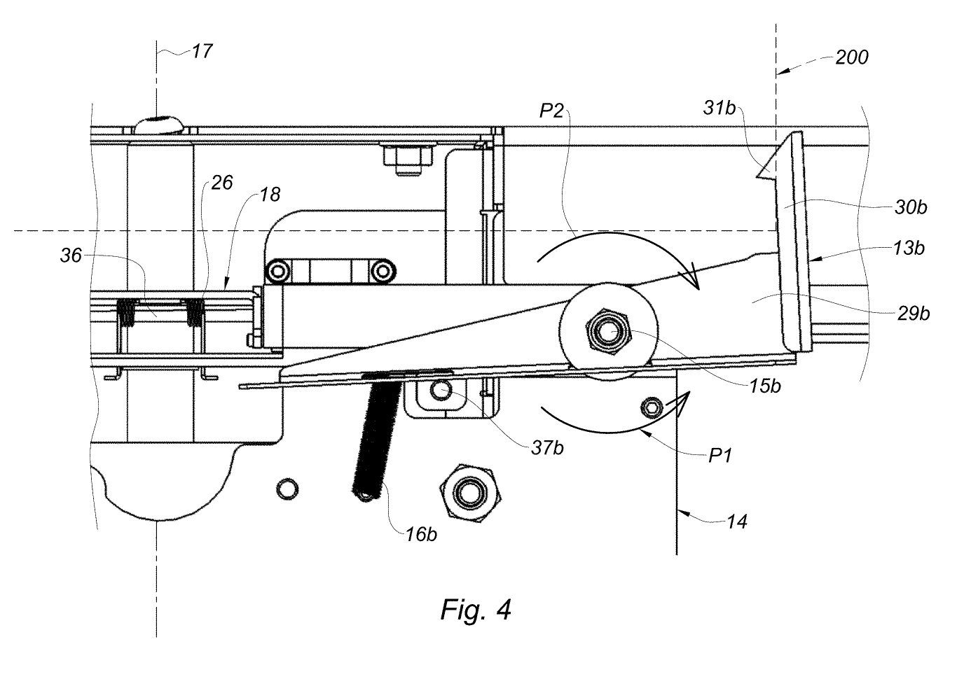

When the jaws 13a, 13b are in the closed position, said jaws 13a, 13b grasp or grip the cardboard box 200. In other words, in the closed position, the jaws 13a, 13b are in engagement with or else retain the cardboard box 200. In other words, in the closed position, the jaws 13a, 13b are integral with the cardboard box 200. In FIG. 4, jaw 13b is illustrated in the closed position, grasping the cardboard box 200.

In the closed position, the jaws 13a, 13b grip opposite side walls of the cardboard box 200, for example. The gripped side walls of the cardboard box 200 are, for example, arranged roughly perpendicularly to the transverse direction Y.

When the jaws 13a, 13b are in the open position, said jaws 13a, 13b release the cardboard box 200. In other words, in the open position of the jaws 13a, 13b, the cardboard box 200 is free to move relative to the jaws 13a, 13b.

When the jaws 13a, 13b swivel from the open position to the closed position, each of the jaws 13a, 13b swivels in the first direction of swivelling P1 about its swivel axis 15a, 15b. Conversely, when the jaws 13a, 13b swivel from the closed position to the open position, each of the jaws 13a, 13b swivels in the second direction of swivelling P2 about its swivel axis 15a, 15b.

The first directions of swivelling P1 of the jaws 13a, 13b are opposite. Moreover, the second directions of swivelling P2 of the jaws 13a, 13b are opposite (FIGS. 1, 2 and 4).

The gripping device 12 further comprises first elastic return members 16a, 16b designed to cause swivelling of each of the jaws 13a, 13b in the first direction of swivelling P1 about its swivel axis 15a, 15b from the open position to the closed position. In other words, the first elastic return members 16a, 16b are designed for returning each of the jaws 13a, 13b to the closed position by swivelling in the first direction of swivelling P1 about its swivel axis 15a, 15b.

In this way, without applying an external force on the jaws 13a, 13b opposing that of the first elastic return members 16a, 16b, the jaws 13a, 13b are in the closed position. In other words, by default, jaws 13a, 13b are in the closed position.

The gripping device 12 is mounted, by means of the support 14, movably in translation on the frame 11 along a first axis of translation 17, roughly orthogonal with respect to the swivel axes 15a, 15b of the jaws 13a, 13b.

The first axis of translation 17 is, for example, horizontal, in particular roughly parallel to the longitudinal direction X.

The gripping device 12 is designed, by means of the support 14, to move in translation relative to the frame 11 along the first axis of translation 17 between a forward position and a retracted position.

When the gripping device 12 is in the forward position, the jaws 13a, 13b are in the closed position and grasp or grip the cardboard box 200.

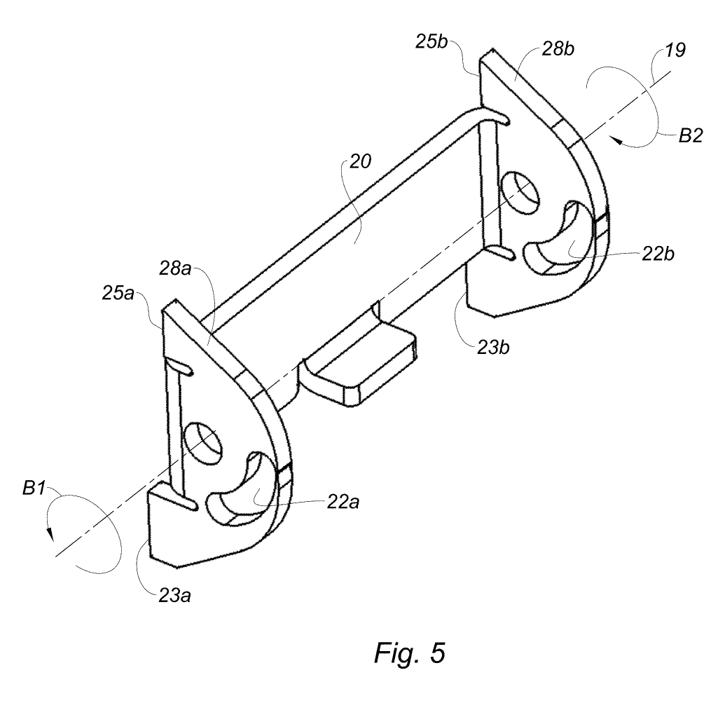

In FIGS. 1 to 3, the gripping device 12 moves from the retracted position to the forward position. In FIG. 4, the gripping device 12 moves from the forward position to the retracted position. In FIG. 5, the gripping device 12 reaches the retracted position.

The gripping device 12 further comprises a blocking piece 18 designed for blocking the jaws 13a, 13b in the open position, when the gripping device 12 moves from the retracted position to the forward position, and for releasing the jaws 13a, 13b when the gripping device 12 reaches the forward position. FIGS. 1 to 3 show the blocking of the jaws 13a, 13b in the open position.

In this way, when the gripping device 12 is in the forward position, the blocking piece 18 releases the jaws 13a, 13b that were in the open position and that then swivel in their first direction of swivelling P1, under the action of the first elastic return members 16a, 16b, from the open position to the closed position, and will thus grip the cardboard box 200.

This is particularly advantageous, since the jaws 13a, 13b advance towards the cardboard box 200 in the open position and only close on said cardboard box 200 once the cardboard box 200 is already positioned between said jaws 13a, 13b. In other words, opening and closing of the jaws 13a, 13b does not depend on an interaction between the jaws 13a, 13b and the cardboard box 200. The risk of the jaws 13a, 13b not succeeding in grasping or gripping the cardboard box 200 is thus limited.

Moreover, gripping of the cardboard box 200 by the jaws 13a, 13b is no longer dependent on precise positioning of the cardboard box 200 relative to the jaws 13a, 13b, notably in the transverse direction Y. In other words, advance of the jaws 13a, 13b in the open position allows greater clearance, notably in the transverse direction Y, for positioning the cardboard box 200 relative to said jaws 13a, 13b.

Furthermore, if the cardboard box 200 is not sufficiently rigid or if the cardboard box 200 has been softened by humidity, it does not risk preventing the jaws 13a, 13b from grasping said cardboard box 200, as the opening and closing of the jaws 13a, 13b does not allow this to occur.

The blocking piece 18 is, for example, mounted tilting on the support 14 in opposite first and second directions of tilting B1, B2 about a tilting axis 19, roughly orthogonal to the swivel axes 15a, 15b of the jaws 13a, 13b, between a blocking position and a release position.

The tilting axis 19 is, for example, horizontal, in particular roughly perpendicular to the first axis of translation 17. The tilting axis 19 is, for example, roughly parallel to the transverse direction Y.

When the blocking piece 18 is in the blocking position and the jaws 13a, 13b are in the open position, the blocking piece 18 blocks each of the jaws 13a, 13b by swivelling in the first direction of swivelling P1 to the closed position. The jaws 13a, 13b are then blocked in the open position. When the blocking piece 18 is in the release position, the blocking piece 18 releases the jaws 13a, 13b. In other words, when the blocking piece 18 is in the release position, each of the jaws 13a, 13b is free to swivel about its swivel axis 15a, 15b relative to the blocking piece 18.

When the blocking piece 18 tilts from the release position to the blocking position, the blocking piece 18 tilts in the first direction of tilting B1 about the tilting axis 19. Conversely, when the blocking piece 18 tilts from the blocking position to the release position, the blocking piece 18 tilts in the second direction of tilting B2.

An example of a blocking piece 18 is shown in more detail in FIG. 5.

The blocking piece 18 comprises, for example, a core 20, flat overall, arranged roughly parallel to the tilting axis 19.

The blocking piece 18 may further comprise a pair of wings 21a, 21b each extending roughly perpendicularly to the tilting axis 19 from one end of the core 20 following the tilting axis 19.

The blocking piece 18 thus has an overall U-shape.

The blocking piece 18 is, for example, mounted tilting on the support 14 by means of the wings 21a, 21b of said blocking piece 18.

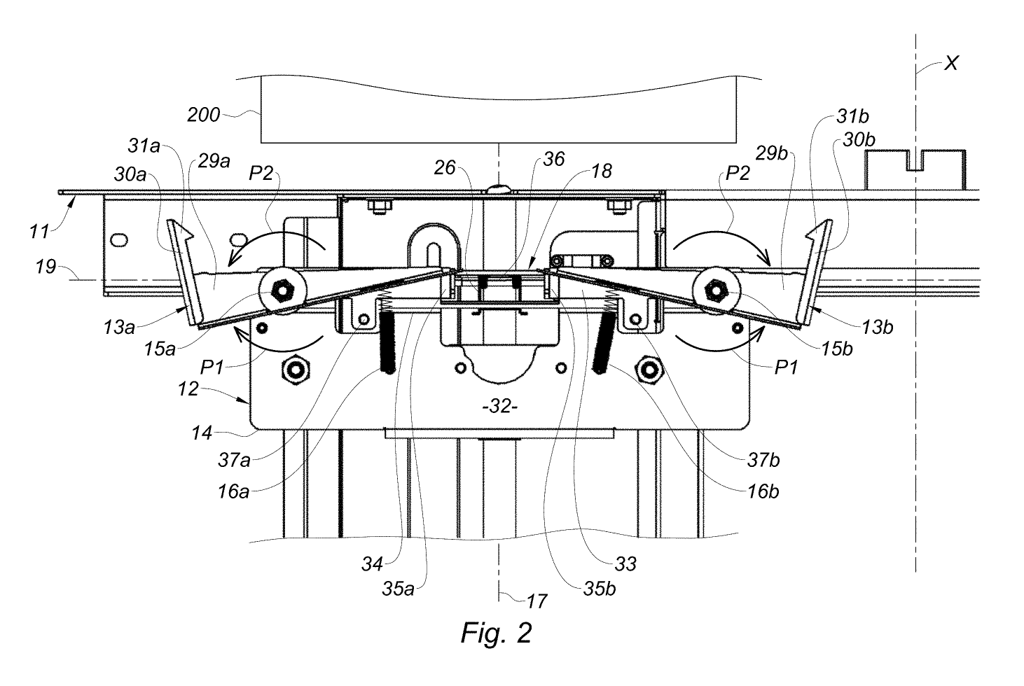

For this, the wings 21a, 21b comprise, for example, openings extending along the tilting axis 19 and receiving a screw 36 integral with the support 14 (FIGS. 2, 3 and 4).

For example, the core 20 is arranged roughly perpendicularly relative to the first axis of translation 17, when the blocking piece 18 is in the blocking position.

The wings 21a, 21b of the blocking piece 18 may each further comprise a slot 22a, 22b designed to interact with a pin integral with the support 14 and extending parallel to the tilting axis 19, so as to guide the tilting of the blocking piece 18 between the blocking position and the release position and limit the angular portion over which the blocking piece 18 tilts about the tilting axis 19 between the blocking position and the release position. The slot 22a, 22b constrains the blocking piece 18 to tilt in the first direction of tilting B1 from the release position to the blocking position and in the second direction of tilting B2 from the blocking position to the release position.

The blocking piece 18 comprises, for example, a first blocking surface 23a, 23b against which the jaws 13a, 13b bear when the blocking piece 18 is in the blocking position and the jaws 13a, 13b are in the open position.

The first blocking surface 23a, 23b of the blocking piece 18 is, for example, provided on each of the wings 21a, 21b of the blocking piece 18.

The first blocking surface 23a, 23b of the blocking piece 18 is, for example, roughly arranged perpendicularly to the first axis of translation 17, when the blocking piece 18 is in the blocking position.

The first blocking surface 23a, 23b of the blocking piece 18 may moreover be arranged opposite the side wall of the cardboard box 200 facing the carriage 10, when the blocking piece 18 is in the blocking position.

The first blocking surface 23a, 23b of the blocking piece 18 may moreover be arranged opposite the core 20 of the blocking piece 18.

The blocking piece 18 is, for example, designed to tilt in the second direction of tilting B2 about the tilting axis 19 from the blocking position to the release position, when the gripping device 12 moves from the retracted position to the forward position.

When the blocking piece 18 is in the blocking position and the gripping device 12 moves from the retracted position to the forward position, said blocking piece 18 blocks the jaws 13a, 13b in the open position. When the blocking piece 18 is in the release position and the gripping device 12 reaches the forward position, said blocking piece 18 releases the jaws 13a, 13b, so that each of the jaws 13a, 13b swivels in the first direction of swivelling P1 to the closed position, under the effect of the first elastic return members 16a, 16b, thus grasping the cardboard box 200.

In this way, the blocking piece 18 reaches the release position when the gripping device 12 reaches the forward position, thus causing closure of the jaws 13a, 13b on the cardboard box 200.

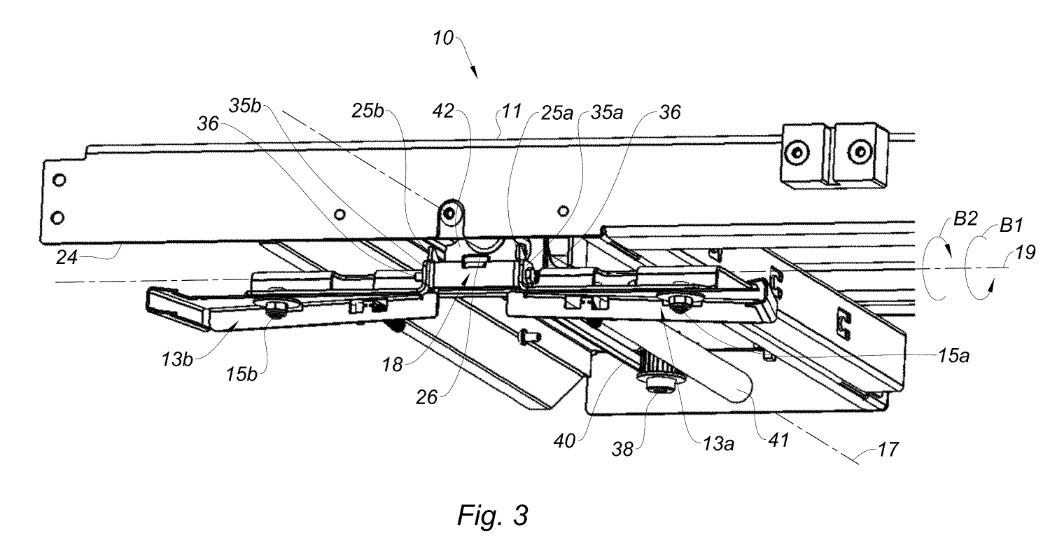

The frame 11 comprises, for example, a first blocking surface 24 designed for causing the blocking piece 18 to tilt in the second direction of tilting B2 about the tilting axis 19 from the blocking position to the release position, when the gripping device 12 moves from the retracted position to the forward position. An example of a first blocking surface 24 is shown in FIG. 3.

The first blocking surface 24 of the frame 11 is fixed relative to the frame 11, so that it is the movement of the gripping device 12 relative to the frame 11 that allows the first blocking surface 24 to cause tilting of the blocking piece 18, once the blocking piece 18 bears against the first blocking surface 24.

The first blocking surface 24 of the frame 11 is, for example, arranged roughly perpendicularly relative to the axis of translation 17 and opposite the blocking piece 18.

The blocking piece 18 comprises, for example, a second blocking surface 25a, 25b designed to interact with the first blocking surface 24 of the frame 11.

The second blocking surface 25a, 25b of the blocking piece 18 is, for example, arranged roughly perpendicularly to the axis of translation 17 when the blocking piece 18 is in the blocking position. The second blocking surface 25a, 25b of the blocking piece 18 is, for example arranged, opposite the first blocking surface 24 of the frame 11 when the blocking piece 18 is in the blocking position.

The second blocking surface 25a, 25b is for example provided on each of the wings 21a, 21b of the blocking piece 18. The second blocking surface 25a, 25b may moreover be arranged opposite the core 20 of the blocking piece 18.

The first blocking surface 23a, 23b and the second blocking surface 25a, 25b of the blocking piece 18 are, for example, arranged on either side of a plane roughly perpendicular to the core 20 and comprising the tilting axis 19.

The blocking piece 18 may also comprise second elastic return members 26 designed for causing the blocking piece 18 to tilt in the first direction of tilting B1 about the tilting axis 19 from the release position to the blocking position. In other words, the second elastic return members 26 are designed for returning the blocking piece 18 to the blocking position by tilting in the first direction of tilting B1 about the tilting axis 19.

In this way, without applying an external force on the blocking piece 18 opposing that of the second elastic return members 26, the blocking piece 18 is in the blocking position. In other words, by default, the blocking piece 18 is in the blocking position.

Thus, when the gripping device 12 reaches the forward position and the blocking piece 18 releases the jaws 13a, 13b that are closing on the cardboard box 200 to grip it, the blocking piece 18 tilts in the first direction of tilting B1 from the release position to the blocking position under the effect of the second elastic return members 26. The gripping device 12 may then move back with the blocking piece 18 to the blocking position.

The second elastic return members 26 comprise, for example, at least one torsion spring mounted between the blocking piece 18 and the support 14. The torsion spring 26 comprises, for example, a U-shaped central portion, two helicoidal intermediate portions each extending from the central portion, in opposite directions along the tilting axis 19, and two end portions extending from each of the helicoidal intermediate portions, roughly perpendicularly relative to the tilting axis 19. The central portion of the torsion spring 26 is positioned so that it bears against the blocking piece 18, for example against the core 20 of the blocking piece 18. The helicoidal intermediate portions of the torsion spring 26 are, for example, wound around the screw 36 by means of which the blocking piece 18 tilts about the tilting axis 19 relative to the support 14. The end portions of the torsion spring 26, for example, rest on the support 14 via openings provided in said support 14 and in which said end portions are inserted.

Each of the jaws 13a, 13b is for example designed to swivel in the second direction of swivelling P2 about its swivel axis 15a, 15b from the closed position to the open position, when the gripping device 12 moves from the forward position to the retracted position.

In this way, the jaws 13a, 13b reach the open position when the gripping device 12 reaches the retracted position.

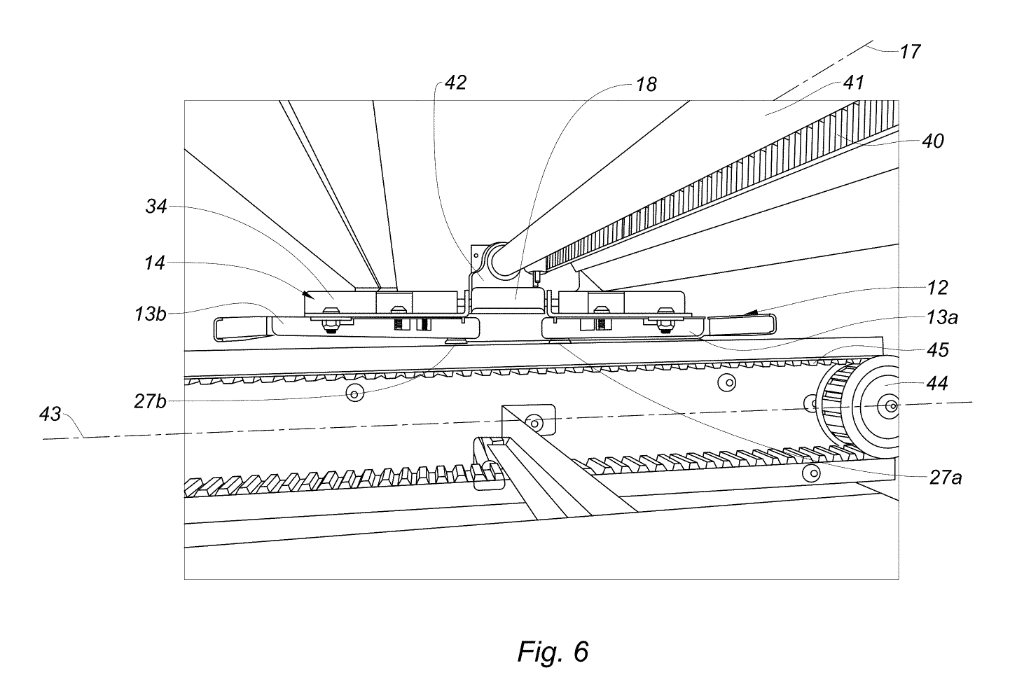

For this, the frame 11 comprises, for example, a second blocking surface 27a, 27b designed to cause each of the jaws 13a, 13b to swivel in the second direction of swivelling P2 about its swivel axis 15a, 15b from the closed position to the open position, when the gripping device 12 moves relative to the frame 11 from the forward position to the retracted position. An example of a second blocking surface 27a, 27b is shown in FIG. 6.

The second blocking surface 27a, 27b is fixed relative to the frame 11, so that it is the movement of the gripping device 12 relative to the frame 11 that allows the second blocking surface 27a, 27b to cause swivelling of the jaws 13a, 13b, once the jaws 13a, 13b bear against the second blocking surface 27a, 27b.

The second blocking surface 27a, 27b comprises, for example, a pair of screws integral with the frame 11, each arranged opposite one of the jaws 13a, 13b.

The jaws 13a, 13b are moreover designed to:
cause the blocking piece 18 to tilt in the second direction of tilting B2 about its tilting axis 19 from the blocking position to the release position, when the gripping device 12 moves from the forward position to the retracted position, and each of the jaws 13a, 13b swivels in the second direction of swivelling P2 about its swivel axis 15a, 15b from the closed position to the open position, and
release the blocking piece 18 when the jaws 13a, 13b reach the open position and the blocking piece 18 reaches the release position.

In this way, when each of the jaws 13a, 13b moves back and swivels in the second direction of swivelling P2 to the open position, the jaw 13a, 13b causes the blocking piece 18 to tilt in the second direction of tilting B2 to the release position. Then, when the jaws 13a, 13b reach the open position and the blocking piece 18 reaches the release position, the jaws 13a, 13b release the blocking piece 18, which tilts in the first direction of tilting B1 to the blocking position, under the effect of the second elastic return members 26, thus blocking the jaws 13a, 13b in the open position.

Thus, when the gripping device 12 is in the retracted position, the jaws 13a, 13b are once again blocked in the open position and are therefore ready to move forward to grasp another cardboard box 200.

For this, the blocking piece 18 comprises, for example, a cam surface 28a, 28b interacting with the jaws 13a, 13b, when said jaws 13a, 13b cause the blocking piece 18 to tilt.

The cam surface 28a, 28b is, for example, designed to guide the jaws 13a, 13b to the first blocking surface 23a, 23b of the blocking piece 18, when the jaws 13a, 13b cause the blocking piece 18 to tilt in the second direction of tilting B2 from the blocking position to the release position.

The cam surface 28a, 28b is for example provided on each of the wings 21a, 21b of the blocking piece 18.

The cam surface 28a, 28b is bevelled, for example, so as to facilitate tilting of the blocking piece 18 caused by the jaws 13a, 13b, when each of the jaws 13a, 13b swivels in the second direction of swivelling P2 to the open position.

The jaws 13a, 13b are, for example, L-shaped.

The jaws 13a, 13b each comprise a first arm 29a, 29b by means of which said jaws 13a, 13b are hinged on the support 14, and a second arm 30a, 30b extending roughly perpendicularly from the first arm 29a, 29b, by means of which the jaws 13a, 13b grip the cardboard box 200.

The end of the first arm 29a, 29b of the jaws 13a, 13b, opposite the second arm 30a, 30b, is designed to interact with the blocking piece 18.

The end of the first arm 29a, 29b of the jaws 13a, 13b is, for example, designed to interact with the first blocking surface 23a, 23b of the blocking piece 18, when the jaw 13a, 13b is in the open position.

The end of the first arm 29a, 29b of the jaws 13a, 13b may also be designed to cause the blocking piece 18 to tilt about the tilting axis 19, when the gripping device 12 moves from the forward position to the retracted position and each of the jaws 13a, 13b swivels about its swivel axis 15a, 15b.

The end of the first arm 29a, 29b of the jaws 13a, 13b may moreover be designed to interact with the cam surface 28a, 28b of the blocking piece 18, when the gripping device 12 moves from the forward position to the retracted position and each of the jaws 13a, 13b swivels about its swivel axis 15a, 15b.

The end of the second arm 30a, 30b of the jaws 13a, 13b, opposite the first arm 29a, 29b, comprises for example pointed projections 31a, 31b extending roughly perpendicularly from the second arm 30a, 30b.

The projections 31a, 31b extend for example opposite one another, when the jaws 13a, 13b are in the closed position.

The projections 31a, 31b will enter the cardboard box 200, notably the opposite side walls of the cardboard box 200, to ensure gripping of said cardboard box 200 by the jaws 13a, 13b.

The support 14 comprises, for example, a first plate 32 and a second plate 33 arranged roughly perpendicularly to the swivel axes 15a, 15b of the jaws 13a, 13b and joined to one another via a step 34 (FIG. 6).

The jaws 13a, 13b are, for example, mounted swivelling on the second plate 33 of the support 14.

The second plate 33 may further comprise a housing designed to receive the blocking piece 18.

The second plate 33 may also comprise a pair of fins 35a, 35b extending roughly perpendicularly to the tilting axis 19 from the edges of the housing, by means of which the blocking piece 18 is mounted swivelling on the support 14. An example of fins 35a, 35b is shown in FIGS. 2 and 3.

The fins 35a, 35b of the support 14 each comprise for example an opening extending along the tilting axis 19, corresponding to the openings of the wings 21a, 21b of the blocking piece 18, and receiving the screw 36 (FIGS. 2, 3 and 4).

The support 14 may also comprise a blocking surface 37a, 37b designed to block the swivelling of each of the jaws 13a, 13b beyond the closed position, when each of the jaws 13a, 13b swivels in the first direction of swivelling P1 towards the closed position under the effect of the first elastic return members 16a, 16b. An example of a blocking surface 37a, 37b of the support 14 is shown in FIGS. 2 and 4.

The blocking surface 37a, 37b of the support 14 thus allows adjustment of the closed position of the jaws 13a, 13b.

The blocking surface 37a, 37b of the support 14 comprises for example a pair of screws integral with the support 14, each arranged opposite one of the jaws 13a, 13b.

The first elastic return members 16a, 16b comprise, for example, a compression spring mounted between each of the jaws 13a, 13b, if applicable between each of the first arms 29a, 29b of the jaws 13a, 13b, and the support 14, if applicable the second plate 33 of the support 14.

The support 14 is for example driven in translation along the first axis of translation 17 by means of a first drive system mounted on the frame 11. An example of a first drive system can be seen in FIGS. 1, 3 and 6.

The first drive system may comprise a driving pulley 38 and a driven pulley (not shown) arranged at opposite ends of the frame 11 along the first axis of translation 17. The driving pulley 38 and driven pulley are mounted with rotation on the frame 11 about a respective axis of rotation roughly parallel to the swivel axes 15a, 15b of the jaws 13a, 13b. The driving pulley 38 is caused to rotate about its axis of rotation by an electric motor (not shown) and in its turn causes rotation of the driven pulley by means of a belt 40 integral with the support 14.

The frame 11 may further comprise a guidance system 41 designed to guide in translation the support 14 along the first axis of translation 17, when the gripping device 12 moves between the forward position and the retracted position. An example of a guidance system 41 is shown in FIGS. 1, 3 and 6.

The guidance system 41 comprises, for example, a tube extending along the first axis of translation 17 on which the support 14 is mounted with sliding along the first axis of translation 17.

The support 14 comprises, for example, at least one guide panel 42 extending roughly perpendicularly to the first axis of translation 17, from the first plate 32 and/or in the extension of the step 33 and comprising an opening of complementary shape with the tube 41. The support 14 is mounted with sliding on the tube 41 via the opening of its guide panel or panels 42.

The frame 11 may also comprise a supporting surface (not shown) arranged perpendicularly to the swivel axes 15a, 15b of the jaws 13a, 13b. The supporting surface is designed to receive the cardboard box 200, when it is gripped and then released by the jaws 13a, 13b and the gripping device 12 moves from the forward position to the retracted position.

The frame 11 may also be provided with a second drive system designed to drive in translation the cardboard box 102 relative to the frame 11 along a second axis of translation 43, roughly perpendicular to the first axis of translation 17 and to the swivel axes 15a, 15b of the jaws 13a, 13b.

The second axis of translation 43 is for example roughly parallel to the transverse direction Y.

The second drive system comprises, for example, a pair of drive subsystems installed at each end of the frame 11 along the first axis of translation 17.

Each drive subsystem comprises, for example, a driving pulley 44 and a driven pulley (not shown) arranged at opposite ends of the frame 11 along the second axis of translation 43. The driving pulley 44 and the driven pulley are mounted with rotation on the frame 11 about a respective axis of rotation roughly parallel to the first axis of translation 17. The driving pulley 44 is caused to rotate about its axis of rotation by an electric motor (not shown) and in its turn causes rotation of the driven pulley by means of a belt 45 flush with the supporting surface.

The operation of the carriage 10 is as follows.

When the gripping device 12 is in the retracted position, the blocking piece 18 is in the blocking position and the jaws 13a, 13b are blocked in the open position by the blocking piece 18.

To grasp a cardboard box 200, the gripping device 12 moves from the retracted position to the forward position, the blocking piece 18 remaining in the blocking position, so as to keep the jaws 13a, 13b in the open position.

During the movement of the gripping device 12 towards the forward position, the blocking piece 18 comes into contact with the first blocking surface 24 of the frame 11 which, under the effect of the movement of the gripping device 12, causes tilting of the blocking piece 18 in the second direction of tilting B2 to the release position.

When the gripping device 12 reaches the forward position, the blocking piece 18 reaches the release position, thus releasing each of the jaws 13a, 13b, which swivel in the first direction of swivelling P1 to the closed position under the effect of the first elastic return members 16a, 16b and thereby grip the cardboard box 200. In its turn, the blocking piece 18 tilts in the first direction of tilting B1 in the blocking position under the effect of the second elastic return members 26, the jaws 13a, 13b remaining free to swivel relative to the blocking piece 18.

The gripping device 12 then moves from the forward position to the retracted position integrally with the cardboard box 200 held by the jaws 13a, 13b.

During the movement of the gripping device 12 to the retracted position, the jaws 13a, 13b come into contact with the second blocking surface 27a, 27b of the frame 11 which, under the effect of the movement of the gripping device 12, causes each of the jaws 13a, 13b to swivel in the second direction of swivelling P2 from the closed position to the open position. As they swivel to the open position, the jaws 13a, 13b themselves cause the blocking piece 18 to swivel in the second direction of tilting B2 to the release position. The jaws 13a, 13b thus gradually release the cardboard box 200 onto the supporting surface of the frame 11.

Then, when the gripping device 12 reaches the retracted position, the jaws 13a, 13b in the open position release the blocking piece 18, which has reached the release position. The blocking piece 18 then tilts in the first direction of tilting B1 to the blocking position under the effect of the second elastic return members 26 and will thus once again block the jaws 13a, 13b in the open position.

The carriage 10 is therefore particularly advantageous as it makes it possible to limit the risk of the jaws 13a, 13b grasping incorrectly or not succeeding in grasping the cardboard box 200, for example when the latter is not sufficiently rigid or when it has been softened under the effect of humidity or when it is not properly centred relative to the jaws 13a, 13b.

It is moreover advantageous as it does not require the addition of a motorized drive specifically dedicated to the opening and closing of the jaws 13a, 13b, the blocking piece 18 making it possible to block the jaws 13a, 13b in the open position and the opening and closing of the jaws 13a, 13b being controlled solely by the movement of said jaws 13a, 13b between the forward position and the retracted position.

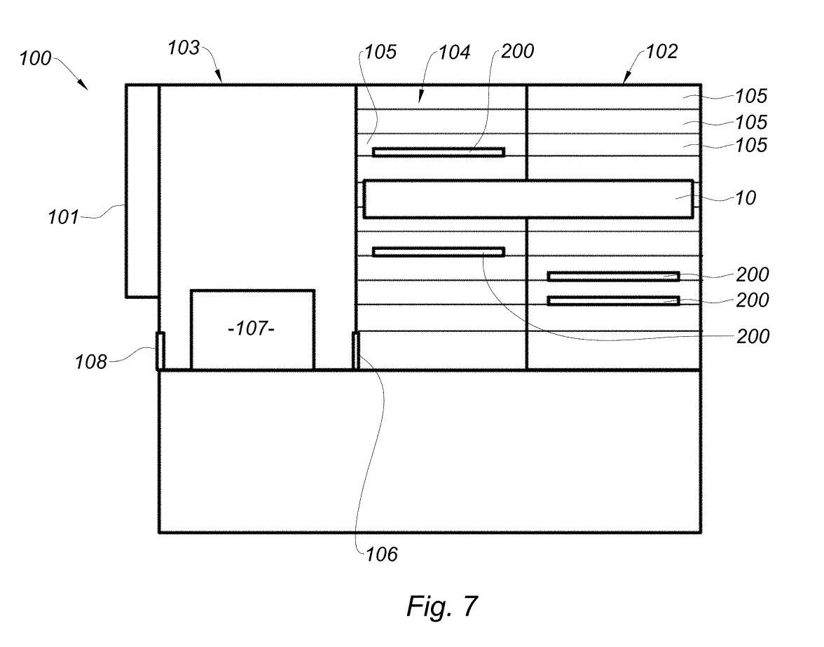

FIG. 7 shows an example of an automatic dispenser 100 of prepared food products comprising the carriage 10.

The dispenser 100 comprises a user interface 101, by means of which a user selects a prepared food product, a control device (not shown) to which the user's selection is transmitted, a storage compartment 102 in which prepared food products are stored in cardboard boxes 200 and a cooking and delivery compartment 103 in which the prepared food product selected by the user is cooked and then delivered to the user.

The storage compartment 102 comprises, for example, shelves 104 designed to receive the cardboard boxes 200 in which the prepared food products are stored.

For this, the shelves 104 may comprise a plurality of boxes 105 arranged on at least one vertical column and each receiving a cardboard box 200. The boxes 105 and therefore the cardboard boxes 200 that they contain are freely accessible in the longitudinal direction X.

The storage compartment 102 further comprises the carriage 10 controlled by the control device.

The carriage 10 is designed to grasp a cardboard box 200 from the shelves 104 and convey said cardboard box 200 to the cooking and delivery compartment 103 via an opening 106 provided between the compartments 102, 103 and having a closing system.

For this, the carriage 10 may, for example, be designed to move in translation in the vertical direction Z between a position of rest in which the carriage 10 is opposite the opening 106 of the dispenser 100 and a gripping position in which the carriage 10 is opposite the cardboard box 200 selected by the user.

The carriage 10 comprises, for example, as many gripping devices 12 as there are columns of boxes 105 in the shelves 104. In this way, it is not necessary to move the gripping device 12 in the transverse direction Y to place it in front of the cardboard box 200 selected.

The cooking and delivery compartment 103 is designed to cook the prepared food product contained in the cardboard box 200 conveyed by the carriage 10 and to deliver the cooked food product in the cardboard box 200 to the user.

For this, the cooking and delivery compartment 103 comprises a cooking oven 107, a carriage (not shown) designed to manipulate the cardboard box 200 in said compartment 103, notably for opening its lid, and a conveyor belt (not shown), or a pulley and belt system similar to those described above, designed to move the cardboard box 200 in translation, for example in the longitudinal direction X towards the cooking oven 107 and in the transverse direction Y towards a delivery opening 108 provided in the dispenser 100 and having a closing and locking system.

In this way, when a user selects a prepared food product via the user interface 101, the carriage 10 moves vertically in the storage compartment 102 so as to place the jaws 13a, 13b opposite the box 105 of the shelves 104 in which the cardboard box 200 comprising the selected prepared food product is located (the gripping position). The gripping device 12 is then in the retracted position.

Then, the gripping device 12 moves from the retracted position to the forward position in which the jaws 13a, 13b grasp the cardboard box 200 as described above.

The gripping device 12 then moves from the forward position to the retracted position, carrying with it the cardboard box 200 until the jaws 13a, 13b open, thus releasing the cardboard box 200 on the supporting surface of the carriage 10.

When the gripping device 12 is in the retracted position, the carriage 10 moves vertically to take up a position opposite the opening 106.

The second drive system of the carriage 10 is then activated so as to move the cardboard box 200 from the storage compartment 102 to the cooking and delivery compartment 103 through the opening 106.

Once inside the cooking and delivery compartment 103, the carriage opens the lid of the cardboard box 200 and the conveyor belt is activated to insert the open cardboard box 200 in the cooking oven 107, where the prepared food product selected by the user is cooked in its cardboard box 200.

On completion of cooking of the prepared food product, the conveyor belt is activated again to bring the cardboard box 200 out of the cooking oven 107, and then deliver the cardboard box 200 and the cooked prepared food product through the delivery opening 108, the carriage simultaneously closing the lid of the cardboard box 200.

1. Carriage (10) for an automatic dispenser (100) of prepared food products, notably of pizza, comprising:
a frame (11),
at least one gripping device (12) designed for grasping a cardboard box (200) comprising a prepared food product, the gripping device (12) comprising:
a support (14),
a pair of jaws (13a, 13b) each hinged on the support (14) about a swivel axis (15a, 15b) in opposite first and second directions of swivelling (P1, P2), each of the jaws (13a, 13b) being designed to swivel about its swivel axis (15a, 15b) between a closed position in which said jaws (13a, 13b) grip the cardboard box (200) and an open position in which the jaws (13a, 13b) release the cardboard box (200),
first elastic return members (16a, 16b) designed to return each of the jaws (13a, 13b) to the closed position by swivelling in the first direction of swivelling (P1) about its swivel axis (15a, 15b),
the support (14) being mounted movably in translation relative to the frame (11) along a first axis of translation (17), roughly orthogonal with respect to the swivel axes (15a, 15b) of the jaws (13a, 13b), the gripping device (12) moreover being designed to move in translation relative to the frame (11) along the first axis of translation (17) between a forward position in which the jaws (13a, 13b) are in the closed position and grip the cardboard box (200) and a retracted position,
wherein the gripping device (12) comprises a blocking piece (18) designed for blocking the jaws (13a, 13b) in the open position, when the gripping device (12) moves from the retracted position to the forward position, and to release the jaws (13a, 13b) when the gripping device (12) reaches the forward position.

2. Carriage (10) according to claim 1, wherein the blocking piece (18) is mounted tilting on the support (14) in opposite first and second directions of tilting (B1, B2) about a tilting axis (19), roughly orthogonal to the axes of articulation (15a, 15b) of the jaws (13a, 13b), between a blocking position in which each of the jaws (13a, 13b) is blocked by swivelling in the first direction of swivelling (P1), when the jaws (13a, 13b) are in the open position, and a release position in which each of the jaws (13a, 13b) is free to swivel about its swivel axis (15a, 15b) relative to the blocking piece (18).

3. Carriage (10) according to claim 2, wherein the blocking piece (18) is designed to tilt in the second direction of tilting (B2) about the tilting axis (19) from the blocking position to the release position, when the gripping device (12) moves from the retracted position to the forward position, to release the swivelling jaws (13a, 13b).

4. Carriage (10) according to claim 2, wherein the frame (11) comprises a first blocking surface (24) designed to cause the blocking piece (18) to tilt in the second direction of tilting (B2) about the tilting axis (19) from the blocking position to the release position, when the gripping device (12) moves from the retracted position to the forward position.

5. Carriage (10) according to claim 2, wherein the blocking piece (18) comprises a first blocking surface (23a, 23b) against which the jaws (13a, 13b) bear when the blocking piece (18) is in the blocking position and the jaws (13a, 13b) are in the open position.

6. Carriage (10) according to claim 2, wherein the blocking piece (18) comprises second elastic return members (26) designed to return the blocking piece (18) to the blocking position by tilting in the first direction of tilting (B1) about the tilting axis (19).

7. Carriage (10) according to claim 1, wherein the frame (11) comprises a second blocking surface (27a, 27b) designed to cause each of the jaws (13a, 13b) to swivel in the second direction of swivelling (P2) about the swivel axis (15a, 15b) from the closed position to the open position, when the gripping device (12) moves relative to the frame (11) from the forward position to the retracted position.

8. Carriage (10) according to claim 7, wherein the jaws (13a, 13b) are moreover designed to:
cause the blocking piece (18) to tilt in the second direction of tilting (B2) about the tilting axis (19) from the blocking position to the release position, when the gripping device (12) moves from the forward position to the retracted position and each of the jaws (13a, 13b) swivels in the second direction of swivelling (P2) about its swivel axis (15a, 15b) from the closed position to the open position, and
release the blocking piece (18) when the jaws (13a, 13b) reach the open position and the blocking piece (18) reaches the release position.

9. Carriage (10) according to claim 8, wherein the blocking piece (18) comprises a cam surface (28a, 28b) interacting with the jaws (13a, 13b), when said jaws (13a, 13b) cause the blocking piece (18) to tilt in the second direction of tilting (B2) about the tilting axis (19) from the blocking position to the release position.

10. Dispenser (100) of prepared food products, notably pizza, comprising a carriage (10) according to claim 1.

11. Carriage (10) according to claim 3, wherein the frame (11) comprises a first blocking surface (24) designed to cause the blocking piece (18) to tilt in the second direction of tilting (B2) about the tilting axis (19) from the blocking position to the release position, when the gripping device (12) moves from the retracted position to the forward position.

12. Carriage (10) according to claim 3, wherein the blocking piece (18) comprises a first blocking surface (23a, 23b) against which the jaws (13a, 13b) bear when the blocking piece (18) is in the blocking position and the jaws (13a, 13b) are in the open position.

13. Carriage (10) according to claim 4, wherein the blocking piece (18) comprises a first blocking surface (23a, 23b) against which the jaws (13a, 13b) bear when the blocking piece (18) is in the blocking position and the jaws (13a, 13b) are in the open position.

14. Carriage (10) according to claim 3, wherein the blocking piece (18) comprises second elastic return members (26) designed to return the blocking piece (18) to the blocking position by tilting in the first direction of tilting (B1) about the tilting axis (19).

15. Carriage (10) according to claim 4, wherein the blocking piece (18) comprises second elastic return members (26) designed to return the blocking piece (18) to the blocking position by tilting in the first direction of tilting (B1) about the tilting axis (19).

16. Carriage (10) according to claim 5, wherein the blocking piece (18) comprises second elastic return members (26) designed to return the blocking piece (18) to the blocking position by tilting in the first direction of tilting (B1) about the tilting axis (19).

17. Carriage (10) according to claim 2, wherein the frame (11) comprises a second blocking surface (27a, 27b) designed to cause each of the jaws (13a, 13b) to swivel in the second direction of swivelling (P2) about the swivel axis (15a, 15b) from the closed position to the open position, when the gripping device (12) moves relative to the frame (11) from the forward position to the retracted position.

18. Carriage (10) according to claim 3, wherein the frame (11) comprises a second blocking surface (27a, 27b) designed to cause each of the jaws (13a, 13b) to swivel in the second direction of swivelling (P2) about the swivel axis (15a, 15b) from the closed position to the open position, when the gripping device (12) moves relative to the frame (11) from the forward position to the retracted position.

19. Carriage (10) according to claim 4, wherein the frame (11) comprises a second blocking surface (27a, 27b) designed to cause each of the jaws (13a, 13b) to swivel in the second direction of swivelling (P2) about the swivel axis (15a, 15b) from the closed position to the open position, when the gripping device (12) moves relative to the frame (11) from the forward position to the retracted position.

20. Carriage (10) according to claim 5, wherein the frame (11) comprises a second blocking surface (27a, 27b) designed to cause each of the jaws (13a, 13b) to swivel in the second direction of swivelling (P2) about the swivel axis (15a, 15b) from the closed position to the open position, when the gripping device (12) moves relative to the frame (11) from the forward position to the retracted position.
